(19) United States
(12) Patent Application Publication
(10) Pub. No.: US 2006/0108154 A1
(43) Pub. Date: May 25, 2006

(54) Device for determining the overall mass of a vehicle

(76) Inventors: Frank Mack, Stuttgart (DE); Thomas Lich, Schwaikheim (DE)

Correspondence Address: KENYON & KENYON LLP, ONE BROADWAY, NEW YORK, NY, 10004, US

(21) Appl. No.: 10/528,571

(22) PCT Filed: Mar. 18, 2003
(86) PCT No.: PCT/DE03/00875

§ 371 Date: Oct. 21, 2005

(30) Foreign Application Priority Data
Sep. 19, 2002 (DE) 10243516.2

(51) Int. Cl. G01G 19/08; G01G 19/14

(52) U.S. Cl. 177/136; 702/174

(57) ABSTRACT

An apparatus for determining the total mass of a vehicle, the apparatus being characterized by the fact that it has stored the curb mass of the vehicle and is connected to distributed weight sensors in the vehicle in order to determine the loaded mass in the vehicle. This includes occupants and luggage or other objects being transported. The total mass is determined by addition, and the kinetic energy is able to be calculated using, when necessary, the mass and a relative velocity between the vehicle and another object. In particular, the apparatus according to the invention allows a center of mass to be determined.

### FIELD OF THE INVENTION

The present invention relates to an apparatus for determining the total mass of a vehicle.

### BACKGROUND INFORMATION

German Published Patent Application No. 198 40 440 describes taking the stored vehicle mass into account in controlling a means of occupant protection. German Published Patent Application No. 44 09 711 describes determining the actual weight of a vehicle using a load sensor. This weight is compared with a setpoint value and, as a function of this, a signal is generated that is taken into account in an evaluation device for restraint means.

A disadvantage of the design approached described in German Published Patent Application. No. 44 09 711 is that the load sensor is difficult to implement and that substantial design measures are required for it to be used on the vehicle.

Thus, the object of the present invention is to create an apparatus for determining the total mass of a vehicle that is substantially easier to implement.

### SUMMARY OF THE INVENTION

The apparatus for determining the total mass of a vehicle according to the invention has, compared to the above, the advantage that it is possible to simply and precisely determine the total mass using already existing passenger-compartment sensing and additional weight sensors that are provided in the vehicle for detecting loads and using a stored value pertaining to the curb weight of the vehicle. Alternatively, it is possible to provide wheel bearing load sensors, which may also be used to determine the total mass of the vehicle. This total mass may then be supplied to additional vehicle systems as a parameter.

It is especially advantageous that the distributed weight sensors are configured to determine the weight of each individual occupant and of a payload, the apparatus having means for determining a mass from a weight. Specifically, this also makes it possible to determine the center of mass. Alternatively, the total mass of the vehicle may also be determined using the wheel bearing load sensors. The individual weight of the wheels is known for each vehicle and may be taken into account in the evaluation.

Furthermore, it is advantageous to have the distributed weight sensors located in the seats and on a cargo surface, for example the floor of the trunk or the roof rack. In this way, it is possible to determine the total mass and also the center of mass with very high accuracy.

It is also advantageous to link this mass value with a relative velocity of an object that is determined using a pre-crash sensing system, in order to determine the kinetic energy upon impact. This value is very important for such vehicle systems as the restraint system, vehicle operation dynamics, or the braking system, and may be used to reduce the severity of a collision. In this way, in particular, it is possible to use these vehicle systems in ways that are adapted to given situations.

### BRIEF DESCRIPTION OF THE DRAWINGS

FIG. 1 shows a block diagram of the apparatus according to the invention in the vehicle.

FIG. 2 shows a flowchart of the process flow that occurs in the apparatus according to the invention.

FIG. 3 shows a block diagram of the apparatus according to the invention.

### DETAILED DESCRIPTION

Since the introduction of the front passenger airbag, in the course of the improvement of restraint systems, sensors as well as processes have been introduced in the passenger compartment whose purpose is to classify the persons in the compartment. Essentially, the purpose of these systems is to protect the passenger properly in the event of a collision depending on the passenger's mass. For this purpose, various systems will be available in the future that will measure or, as necessary, estimate the mass of the occupant. Additional processes for monitoring the passenger compartment with the aid of video cameras or ultrasonic sensing systems will be designed.

For determining the total mass of a vehicle, various methods exist that estimate the total mass based on tire pressure, or that estimate the total mass by way of the suspension properties.

The present invention introduces an apparatus that determines the total mass of the vehicle in a simpler way. It uses in particular and preferably the future vehicle interior sensing system to determine the total mass. In this context, a stored value relating to the curb mass of the vehicle and measured values relating to the payload in the vehicle are added together in order to determine the total mass of the vehicle. For example, weight systems for the occupants that determine the mass or weight as an absolute value are used. The total mass is determined by simply adding together the individual masses and finally adding this to the curb weight.

A further improved calculation may also be accomplished if the trunk and/or the roof rack are also equipped with additional weight sensors. The measurement of the mass on the roof rack may be accomplished, for example, by four washers on the vehicle or through the use of four load-sensing bolts. The determination in the trunk may be accomplished, for example, by a pressure sensor film distributed in an appropriate manner in the trunk.

The total mass of the vehicle may also be determined by wheel bearing load sensors. The individual weight of the wheels is known for each vehicle and may be taken into account in the evaluation. In this way, the precisely measured total weight of the vehicle including occupants and luggage is obtained.

The resulting advantage is manifest in the event of an accident. Here, mass plays an important role because of the kinetic energy that occurs. The formula for calculating kinetic energy is:

$$E = \frac{1}{2} \cdot m \cdot {v}^{2}$$

where m is the total mass of the vehicle in kilograms and v is the velocity of the vehicle or the velocity differential with respect to the impact object in meters per second.

As already described above, the total mass of the vehicle was determined, and the relative velocity of the vehicle as the vehicle is traveling with respect a different object is obtained using a pre-crash sensing system. This is a further input parameter in the evaluation electronics for determining the kinetic energy.

Taking into account the total mass, a controlled strategy for triggering the restraint systems may optionally be developed. A further advantage results for determining the center of mass of the vehicle. Since the distribution of the mass in the vehicle is known based on the various pieces of information, the center of mass of the vehicle may also be determined more effectively. In addition to the classic crash situation, this is also critical for rollover situations in order to be able to determine the vehicle's propensity to tip over more precisely and to trigger the head airbags at precisely the right time.

In addition to crash behavior, other systems may also use this information. This includes systems for improving the characteristics regarding dynamics of vehicular operations or braking performance such as ABS, TCS, ESP, or the brake assist.

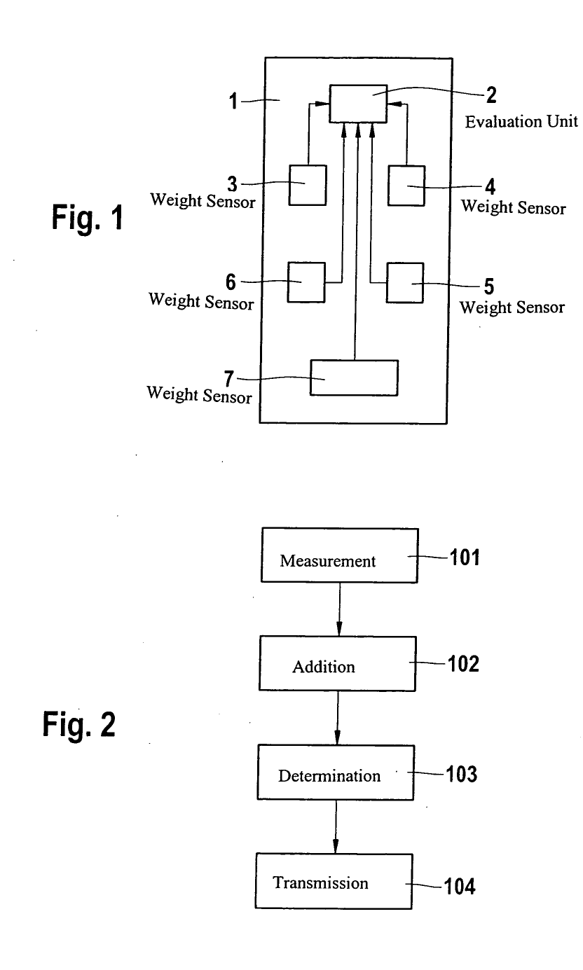

FIG. 1 shows a block diagram for the apparatus according to the invention. A vehicle 1 contains an evaluation unit 2 to which weight sensors 3, 4, 5, 6, and 7 are connected via corresponding data inputs. Weight sensors 3, 4, 5 and 6 are provided for occupant seats in order to determine the weights of the various occupants as needed. Weight sensor 7 is used to measure the weight of the luggage or other objects stored in the vehicle. Many more weight sensors than those shown here may be used. For example, a weight sensor may also be provided for a roof luggage rack, implemented by using corresponding washers.

Evaluation unit 2 processes the data from weight sensors 3 to 7 and, from these values, determines a total mass value. This total mass value is added to the curb mass of the vehicle in order to determine the total mass of the vehicle. The curb weight or curb mass of the vehicle is permanently stored in a memory in evaluation unit 2. Alternatively, wheel bearing load sensors may be provided to determine the total weight or total mass of the vehicle. The total individual weights of the wheels must then also be taken into account. The total mass may then be used as a parameter for other vehicle systems. For example, the kinetic energy in the event of a collision may be calculated from the total mass in combination with a velocity relative to an impact object, and this kinetic energy is important to restraint systems, braking systems, and vehicle dynamic systems in order to protect vehicle occupants as effectively as possible.

FIG. 2 shows in a flowchart the process flow of the apparatus according to the invention. In method step 101, weight sensors 3 to 7 measure the weight that is applied to them. In method step 102, evaluation unit 2 adds the weights that were determined by weight sensors 3 to 7 and from this value determines the corresponding mass. In method step 103, evaluation unit 2 then loads the curb weight or curb mass of vehicle 1 from a memory and adds it to the measured total weight in order to determine the total mass of vehicle 1 including the cargo and occupants. This value is then passed to other vehicle systems in method step 104 in order to optimize the function of these vehicle systems.

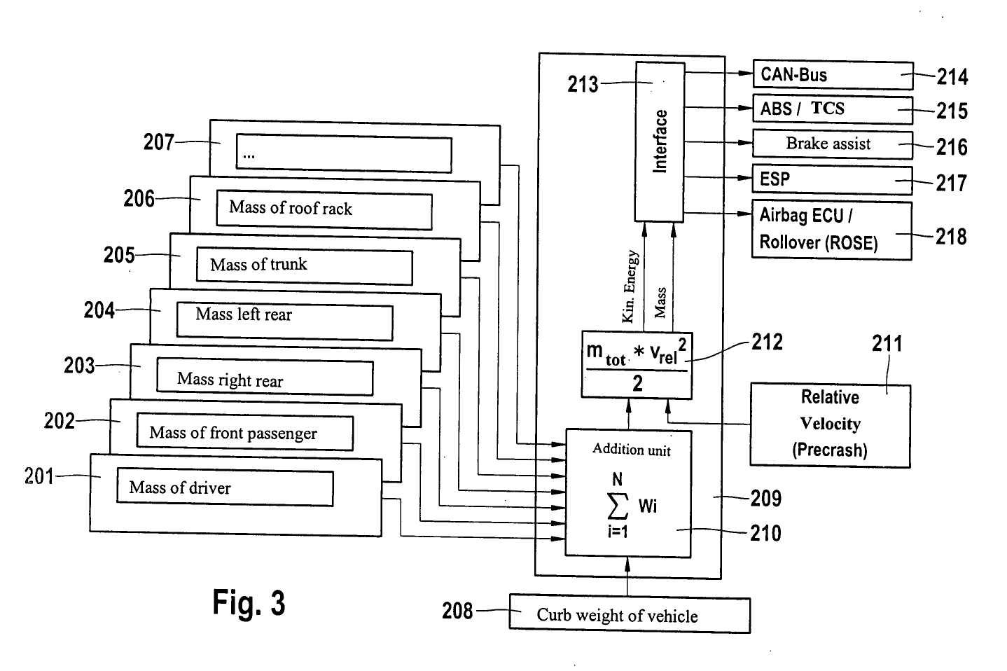

FIG. 3 shows in a block diagram the apparatus according to the invention. Sensors 201 to 207 are connected by corresponding data inputs to an evaluation unit 209 that adds up the measured weight values. In this context, sensor 201 determines the mass of the driver, sensor 202 determines the mass of the front passenger, sensor 203 determines the mass of the right rear passenger, sensor 204 determines the mass of the left rear passenger, sensor 205 determines the mass of the cargo weight in the trunk, sensor 206 determines the mass of the load that is applied on the roof rack, and sensor 207 may be used for additional locations in the vehicle where a load or a passenger may be present, for example in the middle of the rear seat.

Addition unit 209 is connected by a further input 208 to a memory 209 in which the curb weight of the vehicle is stored. Addition unit 210, an additional calculation unit 212, and an interface 213 are located in a vehicle system 209 that performs the evaluation here. Addition unit 210 passes the totaled value to calculation unit 212, to which a pre-crash sensing system 211 is also connected. Pre-crash sensing system 211 supplies the relative velocity with respect to an object with which a collision may occur to calculation unit 212. From the total mass and the relative velocity, calculation unit 212 calculates the kinetic energy that would be applied in the event of a collision with the respective object. It is possible to integrate calculation unit 212 or addition unit 210 into a particular vehicle system. Calculation unit 212 then sends to interface 213 the values for the kinetic energy and the mass that the interface distributes to additional vehicle systems, for example via a CAN bus 214. These additional vehicle systems include ABS or TCS, brake assist, ESP or a restraint system 218. Systems 215 to 218 may be connected to interface 213 either via CAN bus 214 or via corresponding paired wire cables.

1-8. (canceled)

9. An apparatus for determining a total mass of a vehicle, comprising:
a plurality of distributed weight sensors for determining a load mass;
a memory for outputting a curb mass of the vehicle; and
an arrangement for relaying a value for the total mass to at least one additional vehicle system.

10. The apparatus as recited in claim 9, further comprising:
an arrangement for determining a mass from a weight, wherein the distributed weight sensors are configured for determining a respective weight of each individual occupant and a payload.

11. The apparatus as recited in claim 9, wherein the distributed weight sensors are located in seats and on a cargo surface.

12. The apparatus as recited in claim 11, wherein the cargo surface is located at least one of in a trunk and in a roof rack.

13. The apparatus as recited in claim 9, wherein:
the at least one additional vehicle system is connectable to a pre-crash sensing system, and
the at least one additional vehicle system is configured to determine a kinetic energy from the total mass and a value for a relative velocity between the vehicle and another object.

14. The apparatus as recited in claim 13, wherein:
the at least one additional vehicle system relays at least one of the kinetic energy and the total mass to at least one of a braking system, an electronic stability program, and a restraint system.

15. The apparatus as recited in claim 9, further comprising:
an arrangement for determining a center of mass, the center of mass being accessible to the at least one additional vehicle system.

16. The apparatus as recited in claim 9, wherein the distributed weight sensors include wheel bearing load sensors.
